(19) United States
(12) Patent Application Publication
(10) Pub. No.: US 2007/0066505 A1
(43) Pub. Date: Mar. 22, 2007

(54) Anthocyanases as detergent additives

(75) Inventors: Peggy Knobloch, Bad Tennestedt (DE); Hans Peter Mock, Nachterstedt (DE); Gotthard Kunze, Gatersleben (DE); Steffen Amme, Loderburg (DE)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Institut Fuer Pflanzengenetik und Kulturpflanzenforschung, Gatersleben (DE)

(21) Appl. No.: 11/404,346

(22) Filed: Apr. 14, 2006

(30) Foreign Application Priority Data
Sep. 21, 2005 (DE) 10 2005 045 101.2
Oct. 20, 2005 (DE) 20 2005 016 488.7

(51) Int. Cl. C11D 3/48

(52) U.S. Cl. 510/386

(57) ABSTRACT

The present invention relates to detergents comprising at least one anthocyanase (anthocyanin-β-glucosidase). The invention further relates to methods for cleaning and/or decoloring objects, in particular textiles, methods for decoloring liquids, in particular fruit juices, as well as methods for preventing precipitations in the manufacture and/or storage of anthocyanin-containing drinks, preferably red wine, where the object, liquid or drink to be treated is contacted with at least one anthocyanase (anthocyanin-β-glucosidase). The invention is also directed to the use of an anthocyanase in a detergent and/or a method of the invention.

### CROSS-REFERENCE TO RELATED APPLICATIONS

The present application claims priority to German Patent Application No. DE 10 2005 045 101.2, filed on Sep. 21, 2005 and German Patent Application No. DE 20 2005 016 488.7, filed on Oct. 20, 2005, all of which are hereby incorporated by reference in their entirety.

### BACKGROUND OF THE INVENTION

Anthocyanins (Greek anthos=flower, kyanos=blue) is the generic term for anthocyanidins (aglycons) and anthocyanins (glycoside) which are a subgroup of the flavonoids. They are water-soluble red to blue-violet pigments in leaves, flowers and fruits of plants, preferably located in the outer layers of the plants, such as epidermis and sub-epidermis cells. They are employed as natural pigments in food. As secondary plant pigments, they also have a positive health effect. For example, they comprise a high antioxidative potential.

Anthocyanins have a positive charge in the C-ring and thus differ from other flavonoids. The most frequent compounds in nature are the glycosides of the anthocyanidins, such as cyanidin, delphinidin, malvidin, pelargonidin, peogonidin and petunidin. They differ in the substitution of their phenyl benzopyrylium basic structure with hydroxyl and methyl groups. Anthocyanins are primarily glycolysated with monosaccharides, disaccharides or acylated sugars at position 3 and only to a slight extent at positions 5 and 7. Anthocyanidins occurring in nature are aurantinidin, capensinidin, apigeninidin, cyanidin, delphinidin, europinidin, hirsulidin, 6-hydroxycyanidin, luteolinidin, malvidin, 5-methylcyanidin, pelargonidin, peonidin, peltinidin, rosinidin, and tricetinidin. In nature, anthocyanins are also present as glycosides acylated with phenolic or aliphatic acids increasing their stability. The color of the anthocyanins results from an absorption maximum in the visible range with a wavelength of 465-560 nm. The absorption maximums depend on the structure and the pH value.

Anthocyanin-β-glucosidases (anthocyanases) possess the ability of cleaving β-glycosidic bonds in anthocyanin pigments. This cleavage results in the decoloration of the anthocyanin pigments corresponding to the reaction scheme represented below (also see J. Rupp: Woher kommt die Farbe des Weines? Plus Lucis 2/98, 20-22, 1998). 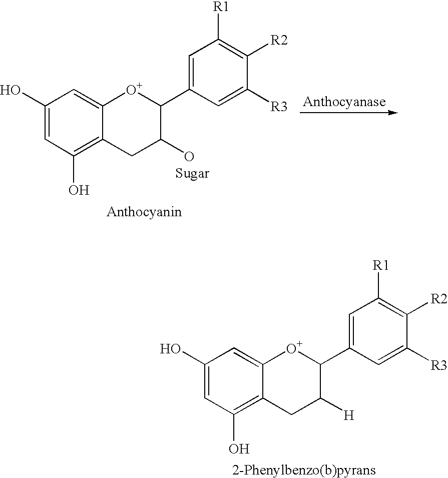
wherein the groups R1, R2 and R3 independently can be hydrogen, hydroxyl or methyl ether groups, depending on the anthocyanin pigment.

Up to now, the enzyme anthocyanase was only employed for removing red colourings in white wine. At present, anthocyanase is recovered from various fungi, such as Aspergillus niger. The anthocyanase recovered from Asp. niger is described as being thermostable and does not meet all the demands for pigment degradation in white wine due to its enzyme properties (H. Blom: Partial characterization of a thermostabile anthocyanin-β-glycosidase from Aspergillus niger, Food Chemistry, 12: 197-204, 1983). Moreover, the Asp. niger strains employed up to now were wild type strains that secrete, besides the anthocyanase, a number of other enzymes not required for anthocyanin degradation into the culture medium.

Within the last few years, an anthocyanin-β-glucosidase was also detected in the yeast C. molischiana (P. Sanchez-Torres et al.: Heterologous expression of a Candida molischiana anthocyanin-β-glucosidase in a wine yeast strain.; J. Agric. Food Chem. 46:354-360, 1998). The enzyme was known for some time, however, it was described as secretory β-glucosidase (P. Gonde et al.: Purification and properties of an exocellular β-glucosidase of Candida molischiana capable of hydrolysing soluble cellodextrins, Can. J. Cell Biol. 63:1160-1166, 1985; S. M. Freer: Production of beta-glucosidase and diauxic usage of sugar mixtures of Candida molischiana, Can. J. Microbiol., 42(5):431-436, 1996; Y. Vasserot et al.: Purification and properties of the β-glucosidase of a new strain of Candida molischiana to work at low pH values: Possible use in the liberation of bound terpenols, J. Basic Microbiol. Vol. 31(4):301-312, 1991). The corresponding anthocyanin-β-glucosidase gene (BGLN gene) comprises 2289 base pairs coding for 763 amino acids. It has been transformed into an S. cerevisiae wine yeast strain and expressed there. The recombinant enzyme had properties similar to those of the original yeast (P. Sanchez-Torres, supra). Since the enzyme yield of these strains is very low, a possible large-scale production of the enzyme in this manner is rather inefficient. However, the demand for anthocyanase is very restricted at present as its applications are not well-known.

Bleaching agents in detergents consist of chemically oxidizing substances, such as chlorine and its oxygen or peroxygen derivates, such as perborate, peroxoacetic acid and others, which are detrimental to health and ecologically problematic. Primarily, the ecological harmfulness of perborate is known, as boron compounds impair the growth of water plants and is generally retained in sewage plants. Moreover, the perborate bleaching agent is only effective starting from approximately 60° C. At this temperature, however, many textiles and tissues are damaged.

Bleaching agents in detergents, such as common washing agents for clothing and other textiles and woven products, respectively, such as carpet, leather, etc., at present contain approximately 15 to 30% of chemical oxidative bleaching agents, such as chlorine and its oxygen and peroxygen compounds, for example perborate, peracetic acid, and others. These are not only detrimental to health but also bring about ecological disadvantages as the sewage disposal is problematic. Another drawback of bleaching agents is their optimum pH and temperature range. For an optimal bleaching effect by peroxygen compounds, high pH values and temperatures of above 60° C. are necessary, which not only attack the cloth but moreover result in high energy costs and a considerable deterioration of the environment.

Within the last few decades, recombinantly produced proteases were added to the detergents, in particular washing agents, in order to decompose protein-containing residues, such as sweat and blood. Due to the protein structure, washing agent proteases are inexpensive and ecological to manufacture, enzymatically highly active at low temperatures and physiological pH values and unproblematic to dispose of. In contrast to chemical additives, which usually are consumed, proteases are individual catalytically acting enzymes which, each for itself, perform many protein cleavages. Therefore, the amount of proteases with respect to other additives can be reduced many times over.

It is an object of the present invention to provide means of making detergents more efficient, inexpensive, ecological in their manufacture, application and disposal, and capable of advantageously replacing at least a part of other additives in detergents. Furthermore, an object underlying the invention is to provide more efficient, inexpensive, ecological methods for cleaning and/or decoloring objects or for decoloring liquids, in particular fruit juices, as well as methods for preventing precipitations in the manufacture and/or storage of anthocyanin-containing drinks.

### BRIEF SUMMARY OF THE INVENTION

The present invention encompasses a detergent comprising at least one anthocyanase (anthocyanin-β-glucosidase).

In one aspect of the invention, the anthocyanase is selected from the group consisting of C. molischiana anthocyanase, S. cerevisiae anthocyanase, Sch. pombe anthocyanase, C. maltosa anthocyanase, D. hansenii anthocyanase, D. vanrijiae anthocyanase, Y. lipolytica anthocyanase, T. beigeleii anthocyanase, T. cutaneum anthocyanase, A. adeninivorans anthocyanase, Kl. Lactis anthocyanase and P. etchellsii anthocyanase.

In another aspect of the invention, the anthocyanase is selected from the group consisting of C. molischiana anthocyanase, S. cerevisiae S288C anthocyanase, Sch. pombe anthocyanase, C. maltosa anthocyanase, D. hansenii 528 anthocyanase, D. vanrijiae anthocyanase, Y. lipolytica H120 anthocyanase, Y. lipolytica H158 anthocyanase, T. beigeleii anthocyanase, T. cutaneum anthocyanase, A. adeninivorans LS3 anthocyanase, Kl. lactis anthocyanase and P. etchellsii anthocyanase.

In still another aspect of the invention, the anthocyanase is selected from the group consisting of C. molischiana anthocyanase, Sch. pombe anthocyanase, D. hansenii anthocyanase, and P. etchellsii anthocyanase.

In another aspect of the invention, the anthocyanase is isolated recombinant anthocyanase or native anthocyanase.

In yet another aspect, the detergent comprises at least one anthocyanase produced in non-conventional yeasts, wherein the non-conventional yeasts are selected from the group consisting of A. adeninivorans, P. pastoris and H. polymorpha.

In still another aspect, the detergent comprises at least one recombinant anthocyanase of A. adeninivorans.

In one aspect, the detergent further comprises a buffer agent and the pH of the detergent is between 3 and 7.

In still another aspect, the pH of the detergent is between 4 and 6.

In yet another aspect, the pH of the detergent is between 4 and 5.

In yet another aspect, the pH is about 4.5.

In another aspect, the detergent comprises a mixture of more than one anthocyanase.

In another embodiment, the detergent is formulated as an unconsolidated powder, tablet, liquid or gel.

In still another embodiment, at least one anthocyanase is present in a powder or a tablet as a lyophylizate.

In yet another embodiment, at least one object is contacted with a detergent comprising at least one anthocyanase (anthocyanin-β-glucosidase) under aqueous conditions.

In still another embodiment, the present invention comprises a method of decoloring objects, wherein at least one object is contacted with a detergent comprising at least one anthocyanase (anthocyanin-β-glucosidase) under aqueous conditions.

In one embodiment, the object is a textile.

In still another embodiment, the object is a textile.

In yet another embodiment, the detergent is the detergent described herein.

In still another embodiment, the detergent is the detergent described herein.

The present invention includes a method for decoloring a liquid, wherein the liquid is contacted with at least one anthocyanase (anthocyanin-β-glucosidase).

In one aspect, the liquid is a fruit juice.

In another aspect, the liquid is red wine.

The present invention includes a method of preventing precipitation in an anthocyanin-containing liquid, wherein the liquid is contacted with at least one anthocyanase (anthocyanin-β-glucosidase).

In one embodiment of the present invention, the liquid is red wine.

### BRIEF DESCRIPTION OF THE DRAWINGS

For the purpose of illustrating the invention, there are depicted in the drawings certain embodiments of the invention. However, the invention is not limited to the precise arrangements and instrumentalities of the embodiments depicted in the drawings.

FIG. 1 is an image depicting the detection of the isolated enzyme-1 (Bglnp; anthocyanase of C. molischiana) in the culture medium on anthocyanin-containing agar plates onto which each 230 ng of active (1) and inactive (2), respectively, anthocyanin-β-glucosidase were applied, and it was all incubated for 18 hours at 37° C.

FIG. 2 is a graph depicting the degradation of the anthocyanin mixture by enzyme-1 (Bglnp; anthocyanase of C. molischiana) after the addition of 0.025 μg (♦) and 0.05 μg, respectively, of enzyme (▪) to 1 ml of anthocyanin solution.

FIG. 3 is a graph depicting anthocyanin degradation in response to the enzyme concentration of enzyme-1 (Bglnp; anthocyanase of C. molischiana). The different values between the zero sample (without incubation) and samples which had been incubated with the enzyme for 1 hour (♦) or 8 hours (▪), respectively, are represented.

FIG. 4 is a graph depicting anthocyanin degradation in response to the anthocyanin concentration by enzyme-1 (Bglnp; anthocyanase of C. molischiana). 0.5 μg of anthocyanase was incubated with various anthocyanin concentrations in 1 ml (optical density=0.5 (▪), optical density=1 (♦)).

FIG. 5 is a graph depicting anthocyanin degradation during a double addition of enzyme-1 (Bglnp; anthocyanase of C. molischiana). 0.0225 μg (♦) and 0.05 μg (▪), respectively, of anthocyanase were added to 1 ml of anthocyanin with an OD of 1. After an incubation time of 2 hours, the corresponding enzyme concentration was added again.

FIG. 6 is a graph depicting β-glucosidase activity of r-enzyme-1 (rBglnp; recombinant anthocyanase of C. molischiana, produced in Arxula adenivorans; ♦) in response to cultivation time. The control strain, A. adeninivorans G1211/pAL-ALEU2m (▪) did not show any β-glucosidase activity. Cultivation occurred in YMM with 2% fructose at 37° C.

FIG. 7 is a bar graph depicting the maximum enzyme activities of enzyme-1 (Bglnp; anthocyanase of C. molischiana), r-enzyme-1 (rBglnp; recombinant anthocyanase of C. molischiana, produced in Arxula adenivorans), and A. adeninivorans G1211/pAL-ALEU2m (without the BGLN gene).

FIG. 8, comprising FIGS. 8A and 8B, is a series of images depicting anthocyanase detection in culture medium of r-enzyme-1 (rBglnp; recombinant anthocyanase of C. molischiana, produced in Arxula adenivorans). FIG. 8A depicts 50 μl of medium of A. adeninivorans G1211/pAL-ALEU2m-BGLN and FIG. 8B depicts G1211/pAL-ALEU2m (without the BGLN gene), respectively, placed onto anthocyanin-containing agar plates, and incubated for 18 hours at 37° C.

FIG. 9 is a graph depicting the dependence of the r-enzyme-1 (rBglnp; recombinant anthocyanase of C. molischiana, produced in Arxula adenivorans) activity on temperature. The enzyme activity was detected in the culture medium at pH 4.0.

FIG. 10 is a graph depicting the correlation of the r-enzyme-1 (rBglnp; recombinant anthocyanase of C. molischiana, produced in Arxula adenivorans) activity with the pH value of the measured solution. The enzyme activity was established in the culture medium at a temperature of 50° C.

FIG. 11 is a graph depicting degradation of the anthocyanin mixture by r-enzyme-1 (rBglnp; recombinant anthocyanase of C. molischiana, produced in Arxula adenivorans). 1.39 μg (♦) and 2.79 μg of enzyme (▪) were added to 1 ml of anthocyanin solution.

FIG. 12 is a graph depicting anthocyanin degradation in response to the anthocyanin concentration by r-enzyme-1 (rBglnp; recombinant anthocyanase of C. molischiana, produced in Arxula adenivorans) using a constant enzyme concentration of 2.79 μg/ml and various anthocyanin concentrations (optical density=0.5 (▪), optical density=1 (♦)).

FIG. 13 is a graph depicting anthocyanin degradation during a double addition of r-enzyme-1 (rBglnp; recombinant anthocyanase of C. molischiana, produced in Arxula adenivorans). To 1 ml of anthocyanin with an OD of 1 were added 42.11 μg (♦) and 84.23 μg (▪), respectively, of anthocyanase. After an incubation time of 2 hours, the corresponding enzyme concentration was added again.

FIG. 14 is a bar graph depicting the secretory β-glucosidase activities of the following various yeasts: S. cerevisiae S288C, C. maltosa, D. hansenii 528, D. vanrijiae, Y. lipolytica H120, Y. lipolytica H158, T. beigeleii, T. cutaneum, A. adeninivorans LS3, and Kl. lactis. For doing so, the yeasts were cultivated in YMM+cellobiose for 48 h at 30° C. and the β-glucosidase activity accumulated in the medium was measured.

FIG. 15 is an image depicting anthocyanase detection in the culture medium of D. hansenii 528 (1), C. molischiana (2), S. cerevisiae S288C (3), and D. vanrijiae (4). 50 μl of an enzyme-containing sample (10-fold concentration) was applied to anthocyanin-containing agar plates and incubated for 16 hours at 37° C.

FIG. 16 is a graph depicting the degradation of an anthocyanin mixture by enzyme-4 (DVantp; anthocyanase of D. vanrijiae) after the addition of 0.4 μg (♦) and 0.8 μg, respectively, of enzyme (▪) to 1 ml of anthocyanin with an OD of 1.0.

FIG. 17 is a graph depicting anthocyanin degradation by enzyme-4 (DVantp; anthocyanase of D. vanrijiae) in response to enzyme concentration. Different values between the zero sample (without incubation) and samples which were incubated with the anthocyanase for 1 hour (♦) and 8 hours (▪), respectively, are represented.

FIG. 18 is a graph depicting anthocyanin degradation by enzyme-4 (DVantp; anthocyanase of D. vanrijiae) in response to the anthocyanin concentration after the incubation of 0.48 μg of anthocyanase with various anthocyanin concentrations in 1 ml (optical density=0.5 (▪), optical density=1 (♦)).

FIG. 19 is a graph depicting anthocyanin degradation during a double addition of enzyme-4 (DVantp; anthocyanase of D. vanrijiae). 0.145 μg (♦) and 0.29 μg (▪), respectively, of anthocyanase were added to 1 ml of anthocyanin with an OD of 1. After an incubation time of 2 hours, the corresponding enzyme concentration was added again.

FIG. 20 is a graph depicting the degradation of an anthocyanin mixture by enzyme-3 (Santp; anthocyanase of S. pombe). 5.45 μg (♦) and 10.9 μg (▪), respectively, of enzyme was added to 1 ml of anthocyanin with an OD of 1.0.

FIG. 21 is a graph depicting anthocyanin degradation by enzyme-3 (Santp; anthocyanase of S. pombe) when various anthocyanin concentrations are employed, using a constant enzyme concentration of 2.79 μg/ml and various anthocyanin concentrations (optical density=0.5 (▪), optical density=1 (♦)).

FIG. 22 is a graph depicting degradation of an anthocyanin mixture by enzyme-2 (Dantp; anthocyanase of D. hansenii). 6.38 μg (♦) and 12.77 μg (▪), respectively, of enzyme was added to 1 ml of anthocyanin with an OD of 1.0.

FIG. 23 is a graph depicting anthocyanin degradation of enzyme-2 (Dantp; anthocyanase of D. hansenii) when various anthocyanin concentrations were employed, using a constant enzyme concentration of 12.7 μg/ml and various anthocyanin concentrations (optical density=0.5 (▪), optical density=1 (♦)).

### DETAILED DESCRIPTION OF THE INVENTION

The present invention relates to detergents comprising at least one anthocyanase (anthocyanin-β-glucosidase). The invention further relates to methods for cleaning and/or decoloring objects, in particular textiles, methods for decoloring liquids, in particular fruit juices, as well as methods for preventing precipitation in the manufacture and/or storage of anthocyanin-containing drinks, preferably red wine, where the object, liquid or drink to be treated is contacted with at least one anthocyanase (anthocyanin-β-glucosidase). The invention is also directed to the use of an anthocyanase in a detergent and/or an inventive method of the invention.

In a first aspect of the invention, these objects are achieved by a detergent comprising at least one anthocyanase (anthocyanin-β-glucosidase).

It was surprisingly found that the enzyme anthocyanase is excellently suited as an additive for detergents. Due to its enzymatic activity, it can at least partially replace the bleaching agents present in a washing agent. Moreover, the optimal boundary conditions of these enzymes, such as pH value and temperature range, are so advantageous that for many sensitive objects to be cleaned, such as high-quality clothing, neither the pH range nor the temperature range have harmful effects. The enzymes can be disposed of in normal sewage without any problems and do not cause any environmental pollution. The activity of the cleaning effect at temperatures at which chemical bleaching agents usually are not effective, e.g. 30° C., moreover saves energy. Anthocyanases (anthocyanin-β-glucosidases) are particularly effective when removing vegetable, in particular fruit and red wine stains, which usual washing agents cannot remove very well or which make necessary severe material-damaging steps.

A detergent is used herein to refer to a water-soluble or liquid organic composition that is able to emulsify oils, hold dirt in suspension, and act as a wetting agent. In one aspect of the present invention, detergent is used in the sense of any composition that can serve for the removal of dirt on objects.

Finally, all anthocyanases can be used for the execution of the invention, wherein, depending on the origin, manufacturing method and structure of the enzymes, there will be differences in the stability with respect to proteases, temperature and pH stability, substrate specificity, and catalytic activity. Without any excessive efforts, one of skill in the art can isolate those enzymes among the many possible sources in nature which best serve the desired application.

In a preferred embodiment of the present invention, the anthocyanase for the inventive detergent is selected from the group of anthocyanases originating from Candida molischiana, Saccharomyces cerevisiae, Schizosaccharomyces pombe, Candida maltosa, Debaryomyces hansenii, Debaryomyces vanrijiae, Yarrowia lipolytica, Trichosporum beigeleii, Trichosporum cutaneum, Arxula adeninivorans, Kluyveromyces lactis or Pichia etchellsii. These enzymes turned out to be very stable and have good catalytic action. The nucleic acid sequences or amino acid sequences, respectively, of the anthocyanases C. molischiana (NCBI: gi:565663), Sch. pombe (gi:6689257), and D. hansenii (30015675) are already accessible to the public in data bases. The sequence information of other anthocyanases are accessible by usual molecular biological techniques using the known and generally available origin organisms by routine methods, which are at last analogous to the methods by which the presently published anthocyanase sequences were determined. More preferred, however, are those anthocyanases that are selected from the group of anthocyanases originating from C. molischiana, S. cerevisiae S288C, Sch. pombe, C. maltosa, D. hansenii 528, D. vanrijiae, Y. lipolytica H120, Y. lipolytica H158, T. beigeleii, T. cutaneum, A. adeninivorans LS3, Kl. lactis or P. etchellsii. The nucleic acid sequences or amino acid sequences of some of these anthocyanases are already accessible to the public in data bases.

In a particularly preferred embodiment, the inventive detergent comprises anthocyanases of the group originating from C. molischiana, Sch. pombe, D. hansenii, and P. etchellsii. These enzymes have a broad substrate specificity for anthocyanins advantageous for detergents and in particular for washing agents, wherein the substrate spectrum can surprisingly differ for the recombinant variants in comparison with the native isolated enzymes. The DNA genes for C. molischiana, Sch. pombe, and D. hansenii are also designated as BGLN, SANT and DANT, respectively.

Most preferred are inventive detergents comprising anthocyanases of P. etchellsii. Surprisingly, their pH optimum is in the neutral to basic range, making these enzymes particularly suitable for washing agents.

The enzymes appropriate for the use in the invention can be isolated native or recombinant, preferably recombinant, anthocyanases. “Native” means an enzyme isolated from the original organism.

In general, yeasts have numerous advantages with respect to other microorganisms in transgenic production. Thus, they are already used for the synthesis of proteins, also including those with catalytic activities. Moreover, the processes introduced and optimized in the art can be advantageously used for the large-scale production of yeast biomass. Yeast cells are, in contrast to bacteria, larger and therefore offer advantages in their processing, they are flexible as to metabolism and nutrition and as wild types ecologically harmless. Meanwhile, there are numerous examples for the production of recombinant intra- and extracellular proteins in S. cerevisiae. In parallel, however, due to more favorable biotechnological properties, so-called non-conventional yeasts are employed for heterologous gene expression, such as A. adeninivorans, P. pastoris, or H. polymorpha.

Preferably, anthocyanases for the use in the invention are produced transgenically, preferably with non-conventional yeast strains. Non-conventional yeast strains are yeasts not belonging to the genus of Saccharomyces. It surprisingly turned out that recombinant anthocyanases can be produced in such high concentrations that their biotechnological manufacture is extremely cost efficient. This provides the basis for biotechnological manufacturing methods for this enzyme, e.g. in the washing agent industry that will certainly need such recombinant anthocyanases for manufacturing inventive detergents in a ton-scale.

More preferably, the detergent comprises at least one anthocyanase produced in non-conventional yeasts, preferably in A. adeninivorans, P. pastoris or H. polymorpha, most preferably in Arxula adeninivorans.

The yeast A. adeninivorans LS3 was first isolated in the wood-processing industry in Siberia. It had similar morphological and biological properties as the yeast Trichosporon adeninivorans which was isolated in The Netherlands. All yeasts being part of the genus Trichosporon were reclassified into the genus Arxula (Arxula adeninivorans). This yeast is described as apathogenic, xerotolerant, ascomycetal, arthrocondial and nitrate positive. A. adeninivorans moreover possesses the ability of utilizing a huge number of substances, such as uric acid, adenine, putrescine and starch as carbon and/or nitrogen source. The thermostability of this yeast is unusual. It is thus capable of still growing at a temperature of 48° C. Further particularities are the high speed of growth, the secretion performance that is higher by 30 to 50% with respect to S. cerevisiae, and the reversible temperature-depending dimorphism. Thus, A. adeninivorans LS3 grows up to a cultivation temperature of 41° C. in the yeast form, at 42° C. as pseudomycelium, and at temperatures above 42° C. as mycelium.

In a particularly preferred embodiment, the detergent comprises at least one recombinant anthocyanase of A. adeninivorans.

As already mentioned, the anthocyanins are not only stable but also extremely active in physiologically acceptable pH ranges.

In a preferred embodiment, an inventive detergent contains a buffer adjusting a pH value of 3 to 7, preferably 4 to 6, more preferred 4 to 5, most preferred approximately 4.5, as such or when contacted with water.

The anthocyanins are not only stable in the major portion of usual temperature ranges, they are also catalytically active in those ranges. In another preferred embodiment, the inventive detergent is optimized for an employment at temperatures of 0 to 80, preferably 20 to 70, more preferred 30 to 60, most preferred 35 to 55, particularly preferred about 50° C. This optimization can, for example, mean that the other ingredients, such as bleaching agents, soaps, buffer substances, odorous substances, are stable in this temperature range and can completely develop their effects.

Detergents are often used in very broad temperature and/or pH ranges. Here, one of skill in the art can either correspondingly select the anthocyanases or else combine them.

Preferably, the invention comprises those detergents comprising a mixture of more than one anthocyanase preferably having various optimal temperature ranges and/or pH ranges.

The detergent can be formulated in any manner, as long as the cleansing activity of the anthocyanases is not essentially impaired. Preferably, the detergent is present as unconsolidated powder, tablet, liquid or gel.

If the detergent is present as powder or tablet, it is preferred that at least one anthocyanase is present as lyophilizate, preferably as granulate, and optionally with additives common for washing agents and/or washing agent proteins.

The detergent comprises any kind of other detergents employed for removing visible dirt, and is preferably a washing agent or stain remover for dirty objects, in particular textiles. In the simplest case, the detergent is the enzyme itself in a solid or aqueous liquid form without any further components.

In another aspect, the invention is related to any methods in which an anthocyanase serves the cleaning, decoloration of objects or liquids or the prevention of precipitations.

In particular, the invention is directed to a method for cleaning or decoloring objects, in particular textiles, in which at least one object is contacted with at least one anthocyanase under aqueous conditions.

In this method, the enzyme is preferably present as an anthocyanase-containing composition, preferably a detergent composition, the above mentioned detergent compositions according to the invention being particularly preferred.

Furthermore, a method for the decoloration of liquids, in particular fruit juices, is preferred, wherein a liquid to be decolored is contacted with at least one anthocyanase.

Particularly preferred for this decoloration are the enzymes also employed in the above mentioned detergent according to the invention.

In a very particular embodiment, the liquid to be decolored is red wine. Before this invention, winemakers have completely decolored red wines with many efforts by column chromatography methods. Such products serve as marketing attraction.

It was moreover surprisingly found that anthocyanases not only highly efficiently decolor anthocyanin-containing drinks but can also prevent pigment precipitations. Therefore, the invention therefore also relates to a method for preventing precipitations in the manufacture and/or storage of anthocyanin-containing drinks, preferably red wine, where the drink to be treated is contacted with at least one anthocyanase.

In a third aspect, the invention is related to the use of at least one anthocyanase in an inventive method. Here, the use of the enzymes mentioned above as being preferred for the detergents represent a preferred embodiment of the use according to the invention.

Particularly preferred is the use of the inventive cleansing solution in one of the above-mentioned methods.

It was surprisingly found that the anthocyanase of P. etchellsii has an extraordinarily high pH optimum for the catalytic activity at pH 6.5. Other anthocyanases in most cases have a pH optimum of pH 4 to 5. The anthocyanase of P. etchellsii is therefore particularly suited for the methods according to the invention.

For the recombinant anthocyanase of C. molischiana, it could be unexpectedly demonstrated that it has a modified substrate profile compared to the native enzyme.

Therefore, the use of a recombinant anthocyanase of C. molischiana in an inventive method according to a method is also a preferred embodiment.

Another aspect of the present invention is related to an anthocyanase of P. etchellsii as well as recombinant anthocyanase of C. molischiana, Sch. pombe, D. hansenii or P. etchellsii.

### EXPERIMENTAL EXAMPLES

The invention is now described with reference to the following Examples. These Examples are provided for the purpose of illustration only and the invention should in no way be construed as being limited to these Examples, but rather should be construed to encompass any and all variations which become evident as a result of the teaching provided herein. Below, the invention is illustrated by means of special embodiments which are not to be considered as restricting the scope of protection.

General Test Conditions

Culture Media and Cultivation Conditions

All bacteria strains (E. coli) were cultivated in solid or liquid bacterial media cultures under aerobic standard conditions. LB complete medium and SOB complete medium were used, the latter optionally as selection medium after the addition of antibiotics after autoclaving.

The yeasts were aerobically cultivated under conditions common for the cultivation in the liquid or solid media with YMM (yeast minimal medium; modified according to Tanaka et al., J. Ferment. Technol. 45:617-326, 1967).

Molecular Biological Methods

In the execution of the following examples of the invention, molecular biological and biochemical methods as well as reagents have been employed as they are acknowledged by one of skill in the art as routine and are easy to produce or are commercially available.

Determination of the β-Glucosidase Activity

The β-glucosidase activity was detected using a calibration curve by means of the cleavage product glucose.

Determination of the Anthocyanase Activity

For enzyme recovery, the following reagents were employed: YMM; 20% cellobiose; 0.5% vitamin mix; ultrafiltration membrane 30000 kDa (mMillipore); nitrocellulose filter, 0.45 μm, Sartorius.

The yeast were cultivated in 2 ml of YMM with 2% cellobiose and 0.5% vitamin mix (40 mg of Ca-D-pantothenate, 40 mg of thiaminedichloride, 10 mg of nicotinic acid, 40 mg of pyridoxine, 0.4 mg of biotin, 400 mg of inosite per 100 ml) for 48 hours at 30° C. After the cultivation, another 10 ml of medium were added. This culture was incubated for another 48 hour at 30° C. The cells were grown up to a cultivation volume of 50 ml. After another incubation time of 48 hours, the yeast cells were separated from the culture supernatant by centrifugation at 10,000×g at 4° C. for 10 minutes. In order to remove all yeast cells from the culture supernatant, the supernatant was additionally filtrated (nitrocellulose filter, 0.45 μm, Sartorius). The supernatant was concentrated to 1:5 by ultrafiltration.

Detection of Anthocyanase Activity

The detection of the anthocyanase activity was performed by means of a plate test with H₂O-agar, 1:55 diluted anthocyanin solution (GNT, EXBERRY Raisin) and an enzyme-containing sample, wherein 50 ml of anthocyanin solution were added to a volume of 400 ml of H₂O-agar. Agar plates were cast with the resulting medium. Subsequently, holes were punched into the anthocyanin-containing agar. 50 μl of concentrated enzyme samples were filled into each of the holes. The agar plates were subsequently incubated at 37° C. for 18 hours.

Vectors and Yeasts

The methods of using vectors and yeasts in the following examples are those employed which are mentioned and described in detail in the German patent application DE 10022334 with the title “Protein production in the yeast Arxula”.

### Example 1

Production of Anthocyanase Producing A. Adeninivorans Strains with the BGLN Gene of Candida Molischiana: Construction of A. Adeninivorans G1211/pAL-ALEU2m-BGLN

The BGLN-ORF was amplified by means of gene-specific primers and chromosomal C. molischiana DNA as template and flanked with the restriction sites for BclI and NotI. The DNA fragment of 2300 bp obtained thereby was cloned into the pCR®2.1-TOPO vector by means of the TOPO TA Cloning Kit and transformed into E. coli TOP 10 F′. Subsequently, the pDNA was isolated from the obtained E. coli transformants and the plasmids were selected via restriction cleavages with subsequent agarose electrophoresis containing the complete BGLN-gene fragment by BclI-NotI restriction. The gene fragment was sequenced and the obtained sequence data were compared to the BGLN gene sequence known from databases. In this manner, the correct amplification of the BGLN fragment was detected.

The BGLN-DNA fragment was integrated into the plasmid pBS-TEF-PHO5 between the TEF1 promotor of A. adeninivorans LS3 and the PHO5 terminator of S. cerevisiae which is functional in the Arxula system. The fragment was cut out of the plasmid pCR2.1-BGLN with BclI and NotI and incorporated into the BamHI-NotI cut plasmid pBS-TEF-PHO5. In the next cloning step, the expression cassette with TEF1 promotor—BGLN gene—PHO5 terminator contained in the resulting plasmid pBS-TEF-BGLN-PHO5 was incorporated into the A. adeninivorans plasmid pAL-ALEU2m via the restriction sites SpeI and SacII. The obtained plasmid pAL-ALEU2m-BGLN was transformed into A. adeninivorans G1211 [aleu2] directly after the linearization with NcoI. All A. adeninivorans G1211 transformants were selected in this transformation strategy by complementation of the aleu2 mutation by the ALEU2m gene. They contain 1-2 plasmid copies which have been stably integrated into the chromosomal 25S rDNA.

### Example 2

Purification of Anthocyanin-β-Glucosidase Synthesized from C. molischiana

The biochemical characterization of the anthocyanin-β-glucosidase (anthocyanase=enzyme-1) originating from C. molischiana was necessary to compare the same with the recombinant anthocyanase synthesized from A. adeninivorans G1211.

Enzyme 1 was purified by means of a DEAE cellulose column using a KCl gradient in Na-phosphate buffer. From the obtained fractions, the protein concentration and the β-glucosidase activity of the anthocyanin-β-glucosidase were determined. In order to obtain a sufficiently high concentration of pure anthocyanase, C. molischiana was cultivated in 1 liter of YMM with 2% cellobiose for 48 hours at 30° C. The use of cellobiose as C-source induces the synthesis of anthocyanase (β-glucosidase) which is subsequently secreted into the medium. The culture medium was concentrated 100-fold by ultrafiltration, and the anthocyanase contained therein was purified via a DEAE cellulose column.

### Example 3

Detection of the Anthocyanase Activity of the Anthocyanin-β-Glucosidase Synthesized in C. Molischiana by Means of a Plate Test

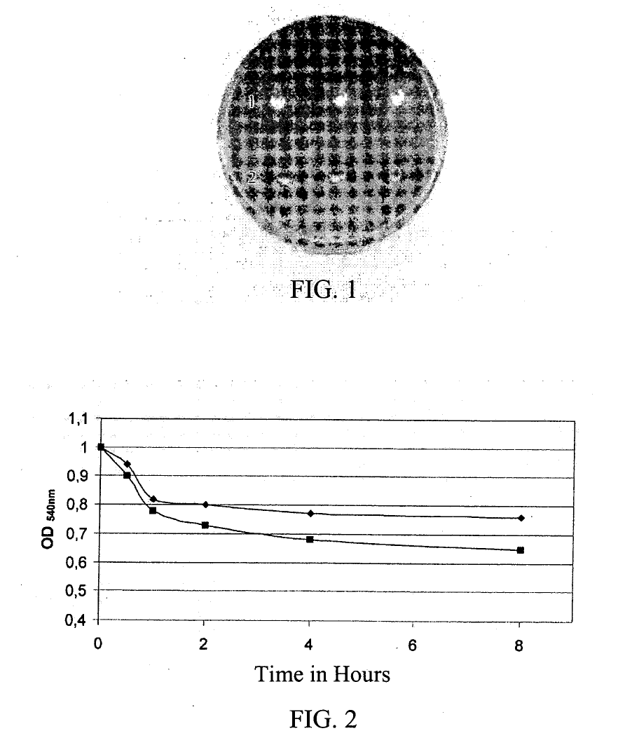

By means of a plate test, the culture medium of C. molischiana was tested for anthocyanin-β-glucosidase activity. 50 μl (230 ng) of anthocyanin-β-glucosidase was applied onto an anthocyanin-containing agar plate and incubated over night at 37° C. In order to exclude dehydration of the pigment, a parallel anthocyanase sample was inactivated by boiling and also applied onto the anthocyanin-containing agar plate. The next day, corona formation was visible around the anthocyanin-β-glucosidase samples with active enzyme, (FIG. 1). In contrast, in the sample with inactive anthocyanin-β-glucosidase, no corona formation was observed, so that a dehydration of the anthocyanin pigment could be excluded.

### Example 4

Biochemical Characterization of the Anthocyanin-β-Glucosidase Synthesized in C. Molischiana

To biochemically characterize the anthocyanase as an anthocyanin-β-glucosidase, a usual β-glucosidase activity determination was performed. For the determination of the optimum temperature, the enzyme sample was incubated at temperatures between 0-70° C. The optimum was 50° C. Within the temperature range of 40-55° C., the enzyme activity was still more than 80%.

To determine the optimum pH, the anthocyanin-β-glucosidase was incubated in substrate buffer mixtures with various pH values for 30 min at 50° C. For determining the pH optimum, this enzyme was tested for its activity between pH 3.0 and 6.0. The activity measurements showed that the pH optimum of the anthocyanase was 4.5. In the pH range between 4.0 and 5.0, the enzyme shows at least 80% of its activity.

Analogous to the temperature and pH optimum, the Kₘ value for cellobiose was determined. It was 6.3 mM. The obtained results comply with the data in literature (Sanchez-Torres, supra) (see Table 1).

TABLE 1
Temperature optimum, pH optimum and Kₘ value for
cellobiose of enzyme-1

| | experimentally | data taken |
|---|---|---|
| | established data | from literature |
| Native molecular weight | 110 kDa | 100 kDa |
| Isoelectric point | 4.71 | 4.71 |
| Temperature optimum | 50° C. | 50° C. |
| pH value optimum | 4.5 | 4.0 |
| Kₘ value for pNPG | 25.86 mM | / |
| Kₘ value for cellobiose | 6.3 mM | / |

To further characterize the β-glucosidase activity, a substrate spectrum was determined. Various substances were tested and the enzyme activity for the corresponding substrate was determined. The substrates are compounds containing glucose in different conformations. The substrates and the β-glucosidase activity of the yeast C. molischiana are shown in Table 2.

TABLE 2
Substrate spectrum of the anthocyanin-β-glucosidase of
C. molischiana

| Substrate | Configuration of the | Enzyme activity |
|---|---|---|
| [10 mM] | glucose ligation | [nkat/ml] at pH 4.0 |
| Amygdalin | Glc (β1→ 6) | 3.14 |
| Cellobiose | Glc (β1→4) | 15.57 |
| Gentiobiose | Glc (β1→6) | 29.75 |
| Lactose | Gal (β1→4) Glc | 0 |
| Maltose | Glc (α1→4) | 48.03 |
| Maltotriose | (α1→4) Glc | 48.43 |
| Saccharose | Glc (α1 [symbol] 2β) Fru | 0 |
| Salicin | Glc (β1→4) | 3.26 |

### Example 5

Decoloration of Anthocyanin by Enzymatic Degradation

The purified anthocyanin-β-glucosidase activity could be determined by the extinction decrease of the red anthocyanin pigment added for reaction. In order to do so, a defined protein concentration was added to the anthocyanin solution (OD_{540 nm}=1) and incubated at 45° C. After various reaction times, the extinction was determined anew at 540 nm and the difference was calculated. This demonstrated that the anthocyanin degradation was effected within 1 hour. In the further course of incubation, only low quantities of anthocyanin were degraded. (FIG. 2)

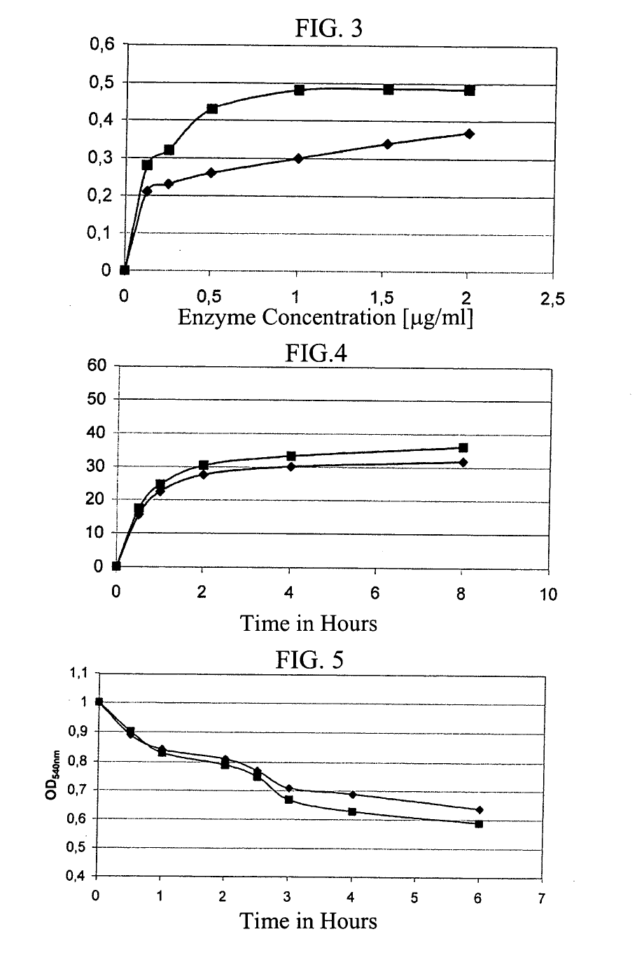

In order to establish whether the anthocyanin degradation correlates with the enzyme concentration, the test was repeated with variable anthocyanin-β-glucosidase concentrations. With an addition of 0.12 μg of enzyme per ml of anthocyanin solution, the extinction decreased within 1 hour from 1.0 to 0.8, i.e. by a difference of 0.2. When the enzyme concentration was increased to 2 μg, the decoloration of the sample also increased, i.e. the extinction decreased from 1.0 to 0.63. In the further reaction course, only a little anthocyanin was cleaved. Thus, after 8 hours of incubation in the presence of 0.12 μg of enzyme, extinction values of 0.72, with 2 μg of anthocyanin-β-glucosidase, of 0.51 were achieved (FIG. 3).

Whether the anthocyanase activity correlates with the anthocyanin concentration was further tested. To this end, 0.5 μg of enzyme were added to anthocyanin with an optical density of 0.5 and 1.0, respectively, and incubated for 8 hours. The data shown in FIG. 4 evidence that the degradation was effected in a similar manner in terms of percentage, i.e. the anthocyanase activity and the anthocyanase concentration correlate.

It was additionally examined whether a higher catalytic action can be achieved if after an incubation of 2 hours anthocyanin-β-glucosidase was added again. To do so, anthocyanin samples (1 ml) with an OD=1, enzyme concentrations of 0.0112 μg and 0.0225 μg, respectively, were added, incubated for 2 hours, and the same enzyme quantity was added again. As is shown in FIG. 5, after the new addition of enzyme, the extinction decreased again, i.e. more anthocyanin was cleaved.

### Example 6

Employment of Specific Anthocyanin Substrates for the Analysis of Anthocyanin Degradation

The previous studies evidence a reduction, not, however, a complete elimination of the color complex. Therefore, the reaction of anthocyanase with specific anthocyanin substrates was tested. To do so, the anthocyanins cyanidin-3-O-glucoside, cyanidin-3-O-galactoside, cyanidin-3-O-rutinoside, and malvidin-3,5-di-O-glucoside were employed as substrates for the enzyme reaction, and the resulting degradation products were analysed by means of HPLC.

As a first anthocyanin substrate, cyanidin-3-O-glucoside with only one glucose molecule as sugar moiety was tested. The substrate was incubated with the anthocyanase for 0 and 120 minutes, respectively, and the corresponding products were analysed by HPLC. Thus it was demonstrated that the glucose molecule of cyanidin-3-O-glucoside was removed by the anthocyanase and the color intensity was reduced.

Cyanidin-3-O-galactoside contains a galactose molecule as sugar. Here, the HPLC results evidence that this substrate was not cleaved by the anthocyanase. Here, even after the enzyme reaction, only the cyanidin-3-O-galactoside peak and no reduction of the color complex was detected.

Cyanidin-3-O-rutinoside contains a rutinoside molecule as sugar. This substance does not serve as substrate for the anthocyanase. There was no reduction of the color complex.

In contrast to the previous substrates, malvidin-3,5-di-O-glucoside contains two glucose molecules which are removed by the anthocyanase. Here, too, the color complex was reduced.

### Example 7

Recombinant Anthocyanase (Bglnp)

A. adeninivorans G1211/pAL-ALEU2m-BGLN was tested for the presence of recombinant anthocyanase (Bglnp-r-enz-1). For doing so, the recombinant enzyme was isolated, purified and biochemically characterized.

a) Detection of the Recombinant Anthocyanase Enzyme

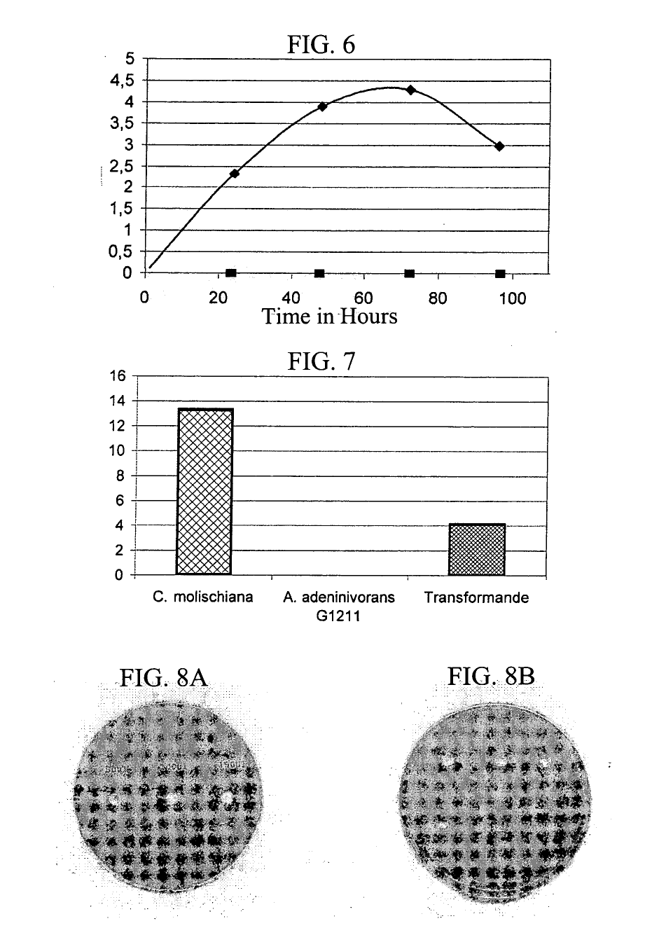

The Arxula transformants were tested for the presence of anthocyanase by determining the β-glucosidase as well as the anthocyanin activity. To do so, A. adeninivorans G1211/pAL-ALEU2m-BGLN was cultivated in YMM with 2% fructose, 5 ml samples were taken every 24 hours, concentrated 50-fold and the recombinant secreted enzyme contained therein was detected. As the β-glucosidases of some fungi are inhibited by glucose, fructose was selected as C-source of the YMM. Already after 24 hours, first β-glucosidase activities could be measured. These increased during the further cultivation and reached their maximum after 72 hours of cultivation (FIG. 6).

In contrast to the transformants, in the BGLN-free strain A. adeninivorans G1211/pAL-ALEU2m, no β-glucosidase activity could be determined under these conditions. In FIG. 7, the maximal enzyme activities of the anthocyanin-β-glucosidase of C. molischiana, the recombinant anthocyanases and A. adeninivorans G1211/pAL-ALEU2m are depicted.

By means of the plate test, the recombinant anthocyanase could be detected. To do so, the culture medium of A. adeninivorans G1211/pAL-ALEU2m-BGLN and A. adeninivorans G1211/pAL-ALEU2m (control) was concentrated approximately 50- to 100-fold, dropped onto anthocyanin containing plates, incubated for 18 hours at 37° C. and tested for corona formation. In contrast to the control, coronas formed around the dropped out media of A. adeninivorans G1211/pAL-ALEU2m-BGLN (FIG. 8).

b) Biochemical Parameters of the Recombinant Anthocyanin-β-Glucosidase (Bglnp)

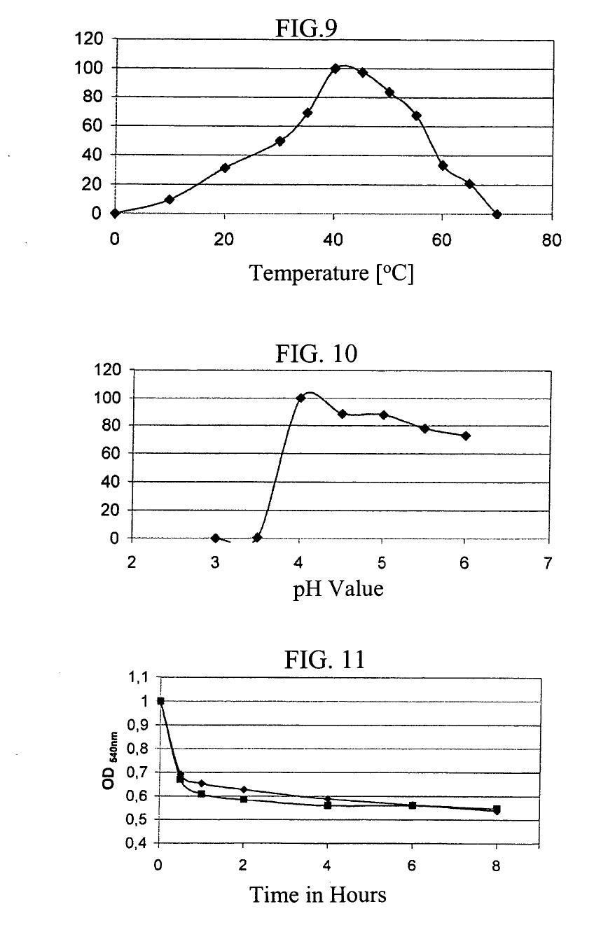

In order to determine to what extent the properties of the recombinant anthocyanase differ from the anthocyanin-β-glucosidase synthesized in C. molischiana, the temperature and pH optima were determined, and the Kₘ value of cellobiose and a substrate spectrum of the native enzyme were established. The recombinant anthocyanase has parameters very similar to those of C. molischiana enzyme (FIG. 9 and FIG. 10).

The temperature optimum was established at 40° C. The temperature range in which this anthocyanase was still has more than 80% activity was between 37.5° C. and 50° C. The optimum pH value was 4.0. However, the recombinant anthocyanase has an essentially broader pH tolerance range than the anthocyanase synthesized in C. molischiana. Thus, its activity was still 80% with a pH value of 5.5. Analogous to the temperature and pH optimum, the Kₘ value was determined for cellobiose and pNPG. The Kₘ value for cellobiose was 58.27 mM and the Kₘ value for pNPG was 5.56 mM.

For the determination of the substrate spectrum of the recombinant anthocyanin-β-glucosidase, the substrates listed in Table 3 were tested. The obtained results differ from those established with the anthocyanin-β-glucosidase of C. molischiana.

TABLE 3
Substrate spectrum of r-enz-1 (rBglnp; recombinant anthocyanase of
C. molischiana produced in Arxula adenivorans).

| Substrates | Configuration of the | Enzyme activity |
|---|---|---|
| [10 mM] | glucose ligation | [nkat/ml] at pH 4.0 |
| Amygdalin | Glc (β1→6) | 49.45 |
| Cellobiose | Glc (β1→4) | 12.5 |
| Gentiobiose | Glc (β1→6) | 20.20 |
| Lactose | Ga (β1→4) Glc | 0 |
| Maltose | Glc (α1→4) | 3.9 |
| Maltotriose | (α1→4) Glc | 14.3 |
| Saccharose | Glc (α1 [symbol] 2β) Fru | 1.0 |
| Salicin | Glc (β1→4) | 2.65 |

c) Anthocyanin Degradation

As a comparison, the anthocyanin degradation of the recombinant anthocyanin-β-glucosidase was also examined. This was also performed via the extinction decrease of the red anthocyanin pigment added to the reaction. Corresponding to the tests with the enzyme of the yeast C. molischiana, a defined protein concentration was added to the anthocyanin solution (OD_{540 nm}=1) and incubated at 45° C. After various reaction times, the extinction was determined again at 540 nm and the difference was calculated. It showed that the anthocyanin degradation was already effected within 0.5 hours. In the further course of the incubation, only low quantities of anthocyanin were degraded (FIG. 11).

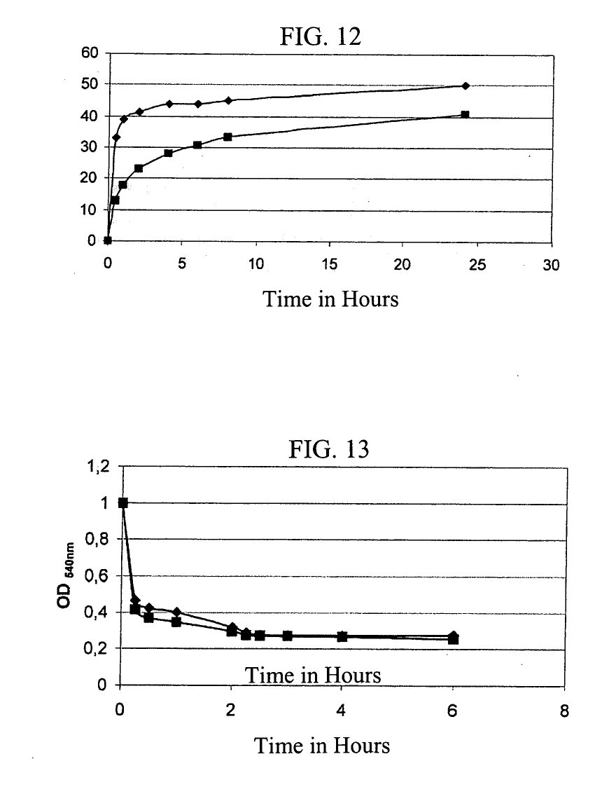

It was further tested whether the anthocyanase activity correlates with the anthocyanin concentration. To measure this, 2.79 μg of enzyme were added to anthocyanin with an optical density of 0.5 and 1.0, respectively, and it was incubated for 24 hours. The data shown in FIG. 12 show that with a higher optical density, and thus with a higher concentration of anthocyanin, more anthocyanin was degraded in terms of percentage.

It was examined in addition whether a higher catalytic effect can be achieved if after an incubation of 2 hours, anthocyanin-β-glucosidase was added again. To do so, anthocyanin samples (1 ml) with an OD=1, enzyme concentrations of 42.119 μg and 84.23 μg, respectively, were added, incubated for 2 hours, and the same amount of enzymes were added again. As shown in FIG. 13, after the new enzyme addition, there was no clear extinction decrease, i.e. no further anthocyanin was cleaved.

d) Employment of Specific Anthocyanin Substrates for Analysing the Anthocyanin Degradation

The recombinant anthocyanase was examined for the cleavage of specific anthocyanins. To measure cleavage, cyanidin-3-O-glucoside, cyanidin-3-O-galactoside, cyanidin-3-O-rutinoside and malvidin-3,5-di-O-glucoside, respectively, were used as substrate for the enzyme reaction, and the resulting degradation products were analyzed by HPLC.

Cyanidin-3-O-glucoside was used as substrate analogously to the native C. molischiana anthocyanin-β-glucosidase. Several degradation products result and lead to a simultaneous reduction of the color complex.

With cyanidin-3-O-galactoside, the HPLC examinations demonstrate that in contrast to the native C. molischiana anthocyanase, a cleavage, and thus a reduction of color intensity, results. Here, differences between the native and the recombinant enzymes occur.

The cyanidin-3-O-rutinoside was not used as substrate by the anthocyanase. Here, no degradation products can be detected in HPLC.

Malvidin-3,5-di-O-glucoside was used in turn as substrate by the recombinant anthocyanase. Here, after the enzyme reaction, degradation products can be detected in HPLC leading to a reduction of the color complex.

### Example 8

Anthocyanase-Secreting Yeasts

In order to provide an optimised selection of anthocyanases and thus to be able to select an anthocyanin-β-glucosidase meeting the required demands for employment in the washing agent industry, a screening for other anthocyanase-secreting yeasts was performed.

a) Screening for ANT Genes of Other Yeasts

In the screening for anthocyanin-β-glucosidase-secreting yeasts, yeasts that can utilize cellobiose and secrete β-glucosidase into the medium for this purpose were selected and tested for their anthocyanase activity. The selected and examined yeasts meeting the required properties are listed in Table 4.

TABLE 4
Yeasts which have been examined for anthocyanase activity
Examined Yeasts

| | |
|---|---|
| S. cerevisiae S288C | Y. lipolytica H158 |
| Sch. pombe | T. beigeleii |
| C. maltosa | T. cutaneum |
| D. hansenii 528 | A. adeninivorans LS3 |
| D. vanrijiae | Kl. lactis |
| Y. lipolytica H120 | P. etchellsii |

b) Detection of β-Glucosidase Activity

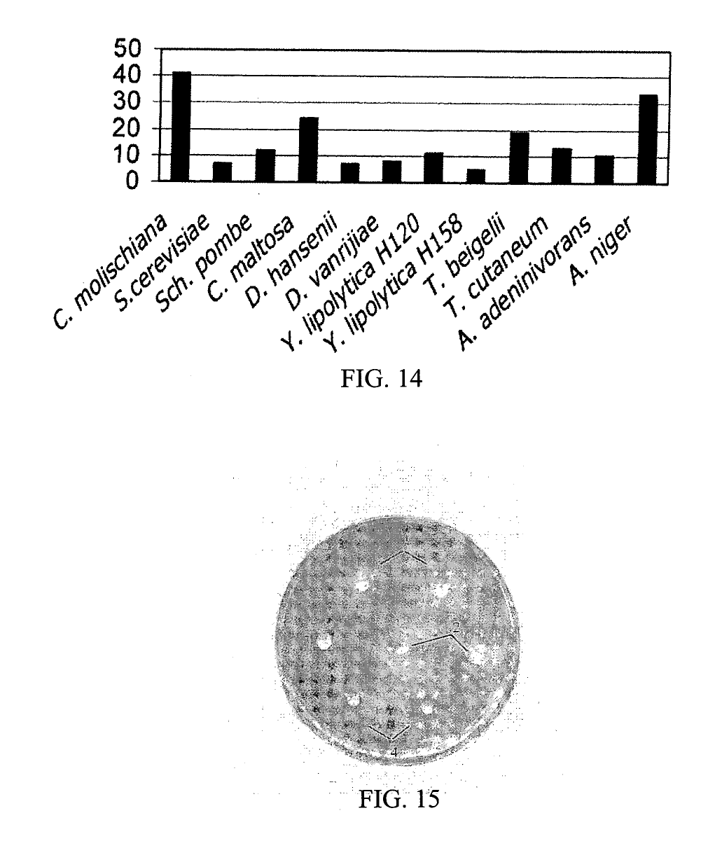

All presently known fungal anthocyanases also have β-glucosidase activities. For this reason, the yeasts known from literature, S. cerevisiae S288C, Sch. pombe, C. maltosa, D. hansenii 528, D. vanrijiae, Y. lipolytica H120, Y. lipolytica H158, T. beigeleii, T. cutaneum, A. adeninivorans LS3, Kl. lactis, and P. etchellsii with cellobiose utilization were tested for β-glucosidase activity. In FIG. 14, the maximal enzyme activities of the yeasts are shown. In the established enzyme activities, all yeasts demonstrated β-glucosidase activity. C. molischiana had the highest activity. Furthermore, Asp. niger 26, C. maltosa, T. beigeleii, T. cutaneum and Sch. pombe showed high β-glucosidase activities. Y. lipolytica H158, S. cerevisiae S288C and D. hansenii 528 only showed very low activities.

c) Analysis of the β-Glucosidase Secreting Yeasts for Anthocyanase Activity

The detection of anthocyanin-β-glucosidase activity was effected analogously to C. molischiana by means of the plate test. To measure this, the yeasts listed in Table 4, S. cerevisiae S288C, Sch. pombe, C. maltosa, D. hansenii 528, D. vanrijiae, Y. lipolytica H120, Y. lipolytica H158, T. beigeleii, T. cutaneum, and A. adeninivorans LS3 were cultivated in YMM and 2% cellobiose for 48 hours. The yeasts were grown up to a final volume of 50 ml, and then the culture supernatant was processed. From this culture supernatant, 50 μl of the 10-fold concentrated samples were applied onto anthocyanin-containing agar plates and incubated at 37° C. (FIG. 15).

By means of the corona formation, the anthocyanase-secreting yeasts could be detected (Table 5). The yeasts D. vanrijiae, Y. lipolytica H120, and Y. lipolytica H158 showed anthocyanase activities. In some other yeasts, anthocyanase activity could only be supposed. For this reason, the culture supernatants were concentrated. In the process, in all examined cellobiose-utilizing yeasts, anthocyanase activity demonstrated correspondingly high concentrations (Table 5).

TABLE 5
Yeast types that have been tested for anthocyanase activity

| | Anthocyanase | required |
|---|---|---|
| Examined yeasts: | activity | concentration |
| C. molischiana | yes | 10-fold |
| S. cerevisiae S288C | yes | 40-fold |
| Sch. pombe | yes | 30-fold |
| C. maltosa | yes | 40-fold |
| D. hansenii 528 | yes | 30-fold |
| D. vanrijiae | yes | 10-fold |
| Y. lipolytica H120 | yes | 10-fold |
| Y. lipolytica H158 | yes | 10-fold |
| T. beigeleii | yes | 30-fold |
| T. cutaneum | yes | 30-fold |
| A. adeninivorans LS3 | yes | 40-fold |
| Kl. lactis | yes | 40-fold |
| P. etchellsii | yes | 10-fold |
| Asp. niger 26 | yes | 10-fold |

C. molischiana and Asp. niger 26 served as positive controls in these experiments.

### Example 9

Biochemical Characterization of Native Anthocyanases

In order to establish an anthocyanase corresponding to the desired demands on detergents, the anthocyanases of the selected yeast strains were biochemically characterized. In these examinations, with all anthocyanases of the up to then examined yeasts, a process analogue to that of the characterization of the C. molischiana anthocyanase was performed.

a) Biochemical Characterization of the Anthocyanase of D. vanrijiae (DVantp; Enzyme 4)

After the purification of the anthocyanase accumulated in the medium via a DEAE cellulose column, the biochemical parameters were established by means of β-glucosidase activity determinations.

Analogous to the anthocyanase of C. molischiana, the temperature optimum, the pH value optimum, the Kₘ value of cellobiose (for the β-glucosidase with anthocyanase activity), and the catalytic degradation of the pigment anthocyanin were established. The results of these examinations are listed in Table 6. Moreover, the molecular weight and the isoelectric point were taken from literature (A. Belancic et al., J. Agric. Food Chem., 51: 1453-1459).

TABLE 6
Temperature optimum, pH value optimum, and Kₘ value
for cellobiose for the anthocyanase of D. vanrijiae.

| | established | literature |
|---|---|---|
| | data | data |
| Molecular weight | / | 100 kDa |
| Isoelectric point | / | 3.0 |
| Temperature optimum | 50° C. | 40° C. |
| pH value optimum | 4.5 | 5.0 |
| Kₘ value for cellobiose | 8.3 mM | / |

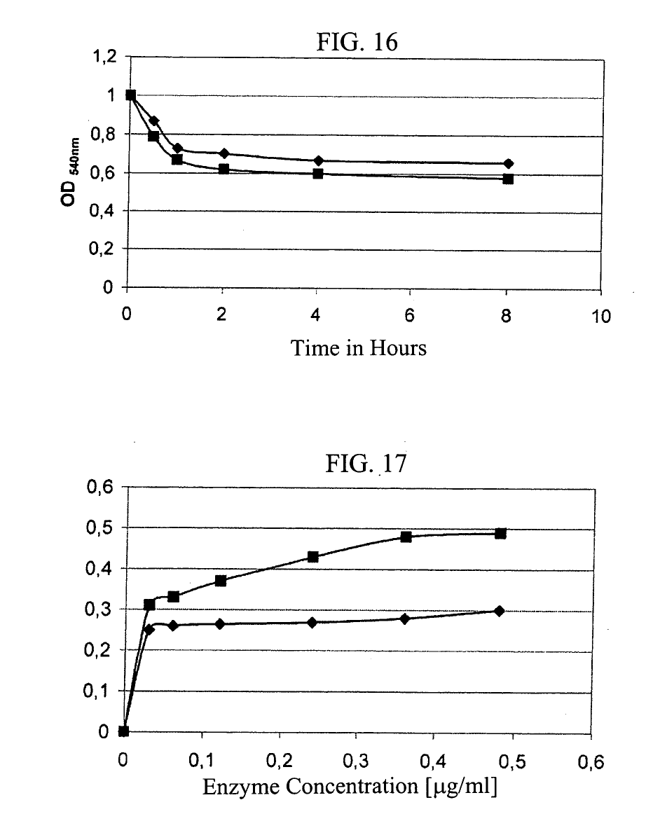

The catalytic reaction of the D. vanrijiae anthocyanase to anthocyanin was also established. To measure this, 0.4 μg and 0.8 μg, respectively, of anthocyanase were added to 1 ml of anthocyanin with an OD of 1.0. Here, too, the anthocyanin degradation was a factor of the incubation time. Within the first hour, already the greater part of the pigment was degraded. Thereafter, the extinction only slowly decreased, i.e. the pigment was slowly degraded (FIG. 16).

For the establishment of the correlation between the anthocyanin degradation and the enzyme concentration, the test was performed with variable anthocyanin-β-glucosidase concentrations.

When 0.03 μg of enzyme per ml anthocyanin were added, the extinction decreased from 1.0 to 0.75 within 1 hour. If the enzyme concentration was increased to 0.5 μg, the decoloration of the sample also increased, i.e. the extinction decreased from 1.0 to 0.7. In the course of the reaction, only little anthocyanin was cleaved. Thus, after 8 hours of incubation in the presence of 0.03 μg of enzyme, extinction values of 0.69; with 0.5 μg of anthocyanin-β-glucosidase, of 0.51 were achieved (FIG. 17).

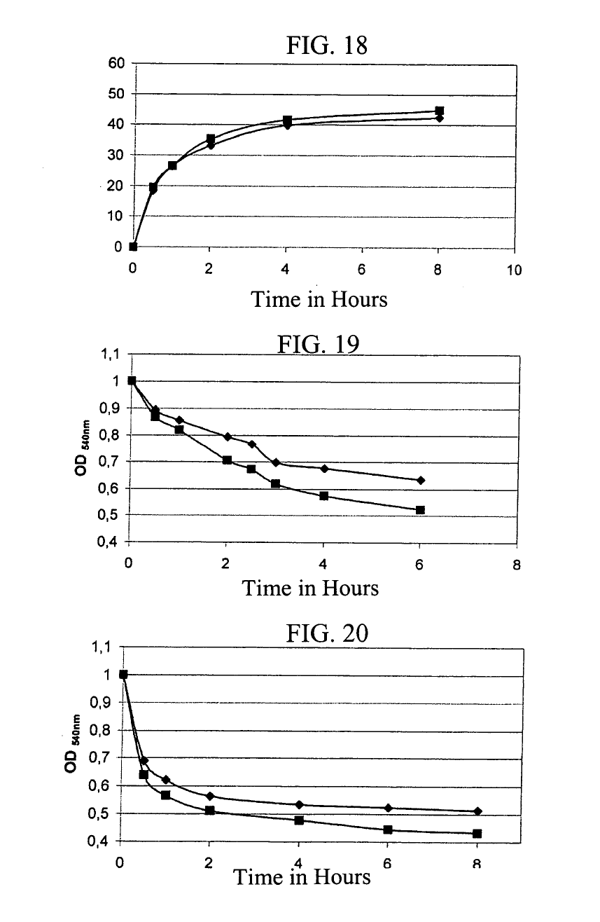

It was furthermore tested whether anthocyanase activity correlates with anthocyanin concentration. To do so, 0.48 μg of enzyme was added to anthocyanin with an optical density of 0.5 and 1.0, respectively, and it was all incubated for 8 hours. The data presented in FIG. 18 evidence that, in terms of percentage, the degradation was effected in a similar manner, i.e. anthocyanase activity and anthocyanin concentration correlate.

It was furthermore examined whether a higher catalytic action can be achieved if after an incubation of 2 hour anthocyanase was added again. For doing so, anthocyanin samples (1 ml) with an OD of 1 were added to enzyme concentrations of 0.145 μg and 0.29 μg, respectively, and it was all incubated for 2 hours, and the same amount of enzyme was added again. As represented in FIG. 19, after the second addition of enzymes, the extinction decreased again, i.e. more anthocyanin was cleaved.

b) Biochemical Characterization of the Anthocyanase of Sch. Pombe (Santp, Enzyme-3)

The biochemical examinations of the anthocyanase (enzyme-3) of Sch. pombe were performed analogously to the C. molischiana anthocyanase. Thus, first their biochemical parameters were established by means of β-glucosidase activity determinations.

The optimum temperature, the optimum pH value as well as the Kₘ values for cellobiose and the catalytic degradation of the pigment anthocyanin were determined. The temperature optimum was 45° C. and the optimal pH value was 4.0. The Kₘ value for cellobiose was 91.86 mM.

As with the previous enzymes, the catalytic reaction of the anthocyanase to anthocyanin was determined. To measure this reaction, 5.45 μg and 10.9 μg, respectively, of anthocyanase were added to 1 ml of anthocyanin with an OD of 1.0. The anthocyanin degradation correlates with the incubation time. Within the first half hour, already the greater part of the pigment was degraded. Thereafter, the extinction only slowly decreased (FIG. 20).

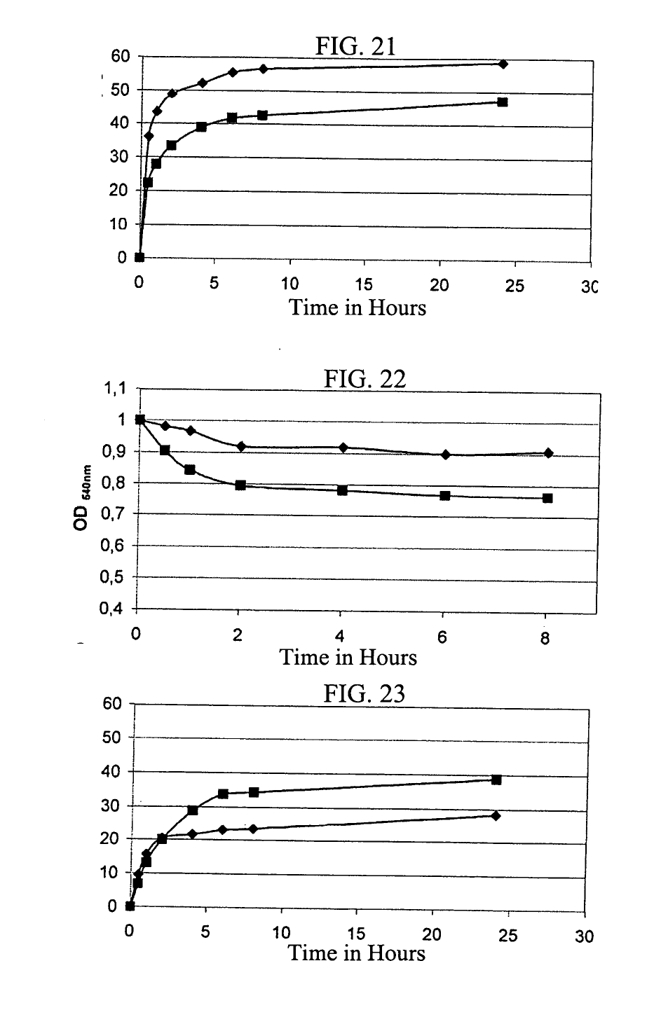

It was further tested to determine the extent the anthocyanase activity correlates with the anthocyanin concentration. To measure this correlation, 2.79 μg of enzyme were added to anthocyanin with an optical density of 0.5 and 1.0, respectively, and incubated for 24 hours. The data shown in FIG. 21 demonstrate that with a higher optical density and thus with a higher concentration of anthocyanin, more anthocyanin was degraded in terms of percentage.

Whether a higher catalytic action can be achieved if after an incubation of 2 hours anthocyanase was added again, was not examined with this anthocyanase.

Characterization of Anthocyanin Degradation with Specific Anthocyanin Substrates

As the yeast Sch. pombe neither exhibits a complete elimination of the pigment complex, here, too, the enzymatic reaction was tested with various specific anthocyanins. To do so, the anthocyanin substrates described elsewhere herein, cyanidin-3-O-glucoside, cyanidin-3-O-galactoside, cyanidin-3-O-rutinoside, and cyanidin-3,5-di-O-glucoside were used and the degradation products were analyzed by means of HPLC. The examination results with respect to the catalytic capability of the enzyme are listed in Table 7.

TABLE 7
Catalytic action of the anthocyanase enzyme-3 (Santp,
anthocyanase of S. pombe) on various anthocyanins

| Anthocyanins | Catalytic reaction |
|---|---|
| Cyanidin-3-O-glucoside | present |
| Cyanidin-3-O-galactoside | not present |
| Cyanidin-3-O-rutinoside | not present |
| Cyanidin-3,5-di-O-glucoside | present |

From the experimental results one can see that this anthocyanase, as the anthocyanase of the yeast C. molischiana, also only shows a catalytic degradation with β-glucosidically bound glucose.

C) Biochemical Characterization of the Anthocyanase of D. hansenii (Dantp; Enzyme-2)

The biochemical examinations of the anthocyanase (enzyme-2) of D. hansenii were performed corresponding to the anthocyanases examined up to then. Thus, their biochemical parameters were determined by means of β-glucosidase activity determinations. The optimum temperature and pH as well as the Kₘ value of cellobiose were analyzed, as was the catalytic degradation of the pigment anthocyanin. D. hansenii anthocyanase has a temperature optimum of 55° C. and a pH optimum of 5.0. The Kₘ value for cellobiose was 16.32 mM. Furthermore, with this yeast, too, one started to establish the substrate spectrum. The obtained data are listed in Table 8.

TABLE 8
Substrate spectrum of the anthocyanase of D. hansenii
(Dantp; enzyme-2)

| Substrate | Configuration of the | Enzyme activity |
|---|---|---|
| [10 mM] | glucose ligation | [nkat/ml] at pH 4.0 |
| Amygdalin | Glc (β1→6) | 4.56 |
| Cellobiose | Glc (β1→4) | 5.94 |
| Gentiobiose | Glc (β1→6) | 19.96 |
| Lactose | Gal (β1→4) Glc | 0 |
| Maltose | Glc (α1→4) | 0.22 |
| Maltotriose | (α1→4) Glc | 0 |
| Saccharose | Glc (α1 [symbol] 2β) Fru | 0 |
| Salicin | Glc (β1→4) | 5.03 |

In addition, the catalytic reaction of D. hansenii anthocyanase to anthocyanin was analyzed. To analyze this catalytic reaction, 6.38 μg and 12.77 μg of anthocyanase were added to 1 ml of anthocyanin with an OD of 1.0, and it was all incubated for various periods at 50° C. Here, too, the anthocyanin degradation depends on the incubation time. Within the first two hours, the greater part of the pigment was degraded. Thereafter, the extinction only slowly decreased, i.e. the pigment was slowly degraded (FIG. 22).

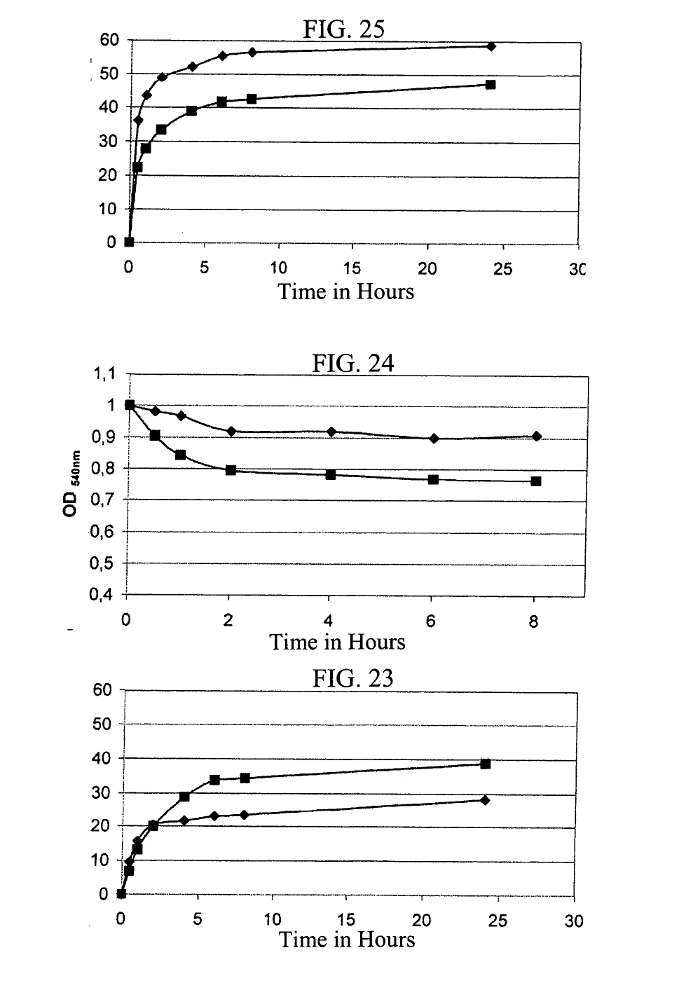

Additionally, the correlation between anthocyanase activity and anthocyanin concentration was tested. For doing so, 12.77 μg of enzyme were added to anthocyanin with an optical density of 0.5 and 1.0, respectively, and incubated for 24 hours. The data shown in FIG. 23 evidence that with a higher optical density and thus with a higher concentration of anthocyanin, less anthocyanin was degraded in terms of percentage.

With the anthocyanase of the yeast D. hansenii, it was also interesting to determine the catalytic action on specific anthocyanin substrates. For this reason, examinations on the catalytic function of the enzyme on the anthocyanin substrates cyanidin-3-O-glucoside, cyanidin-3-O-galactoside, cyanidin-3-O-rutinoside, and cyanidin-3,5-di-O-glucoside were performed. The catalytic capability of the enzyme could be detected by means of HPLC. The results of the enzyme are shown in Table 9.

TABLE 9
Catalytic action of the anthocyanase of D. hansenii
(Dantp; enzyme-2) on various anthocyanins

| Anthocyanins | Catalytic reaction |
|---|---|
| Cyanidin-3-O-glucoside | present |
| Cyanidin-3-O-galactoside | not present |
| Cyanidin-3-O-rutinoside | not present |
| Cyanidin-3,5-di-O-glucoside | low catalytic reaction |

By means of the examination results one can recognize that this anthocyanase, as the anthocyanase of the yeast C. molischiana and Sch. pombe, also only shows a catalytic degradation with β-glucosidically bound glucose. Moreover, this enzyme demonstrates lower activity when two β-glucosidically bound glucose molecules are present.

d) Biochemical Characterization of the Anthocyanase of P. etchellsii (Pantp; enzyme-5)

The biochemical examinations of the anthocyanase (enzyme-5) of P. etchellsii were performed analogously to the anthocyanases examined up to then. Thus, first their biochemical parameters were established by means of β-glucosidase activity determinations.

The optimum temperature and pH values were obtained, and the Kₘ values for cellobiose and pNPG and the catalytic degradation of the specific anthocyanins was determined. The temperature optimum was 50° C. and the optimal pH value was 6.5. The Kₘ value for cellobiose was 84.55 mM and the Kₘ value for pNPG was 59.66 mM.

With the anthocyanase of the yeast P. etchellsii, the catalytic action on the specific anthocyanins was determined. Examinations on the catalytic function of the enzyme on the substrates cyanidin-3-O-glucoside, cyanidin-3-O-galactoside, cyanidin-3-O-rutinoside, and cyanidin-3,5-di-O-glucoside were performed. The catalytic activity of the enzyme was detected as before by HPLC. The examination results of the enzyme are shown in Table 10.

TABLE 10
Catalytic action of the anthocyanase of P. etchellsii
(Pantp; enzyme-5) on various anthocyanins

| Anthocyanins | Catalytic reaction |
|---|---|
| Cyanidin-3-O-glucoside | present |
| Cyanidin-3-O-galactoside | present |
| Cyanidin-3-O-rutinoside | not present |
| Cyanidin-3,5-di-O-glucoside | present |

As demonstrated by the experimental results, this anthocyanase, similar to the recombinant Arxula anthocyanase (BGLNp) of the yeast C. molischiana shows a catalytic degradation with β-glucosidically bound galactose. Here, one cannot exclude that the yeast does not additionally secrete a β-galactosidase responsible of the catalytic degradation of the anthocyanin.

### Example 10

Anthocyanin-Producing A. Adeninivorans Strains with Ant Genes of Sch. Pombe and D. hansenii (rSantp and rDantp)

High-producing strains secreting a recombinant anthocyanase with appropriate biochemical parameters in high concentrations were developed on the basis of the non-conventional yeast A. adeninivorans LS3. For this reason, as already described above, a screen for anthocyanin-β-glucosidase producing yeasts was performed. From the yeasts possessing this property, only those yeasts were registered of which the DNA sequence of the β-glucosidase (identified as anthocyanin-β-glucosidase) was already known. With the aid of the already established DNA sequence, these genes can be isolated and expressed in A. adeninivorans. Thereafter, the recombinant anthocyanases were characterized and appropriate anthocyanin-β-glucosidase was selected for later employment as detergent additive.

The yeasts Sch. pombe and D. hansenii have all features necessary for this. Both yeasts showed anthocyanin-β-glucosidase activity, and their β-glucosidase genes have already been identified. In the isolation and expression of these β-glucosidase genes, a process analogous to that for isolating and expressing the BGLN gene of C. molischiana was employed.

a) Construction of A. Adeninivorans G1211/pAL-ALEU2m-SANTP (Sch. pombe)

The SANTP-ORF was amplified by means of gene-specific primers and chromosomal Sch. pombe DNA as template and flanked first with the restriction kinds for BclI and NotI and secondly flanked with the restriction kinds EcoRI and NotI. The DNA fragments of 1269 bp thus obtained were cloned into the pCR®2.1-TOPO vector by means of the TOPO TA Cloning Kit and transformed into E. coli TOP 10 F′. From the obtained E. coli transformants, the pDNA was subsequently isolated, and the transformants containing the complete SANTP-gene fragment were selected by BclI-NotI and EcoRI-NotI restriction. It was sequenced and the obtained sequence data were compared with the SANTP-gene sequence known from databases. In this manner, the correct amplification of the SANTP fragment was detected.

Analogous to the BGLN-DNA fragment, the SANTP-DNA fragments were integrated into the plasmid pBS-TEF-PHO5 between the TEF1 promotor of A. adeninivorans LS3 and the PHO5 terminator of S. cerevisiae which functions in the Arxula system.

To accomplish this, the fragments were cut out of the respective plasmid pCR2.1-SANTP as BclI-NotI and EcoRI-NotI, and the BclI-NotI fragment was incorporated into the BamHI-NotI cut plasmid and the EcoRI-NotI fragment was incorporated into the EcoRI-NotI cut plasmid pBS-TEF-PHO5. In the process, the EcoRI-NotI fragment was positioned some bases nearer to the promoter than the BclI-NotI fragment. Whether this different positioning has an influence on the expression was to be determined. In the next cloning step, the expression cassettes with TEF1 promotor—SANTP gene—PHO5 terminator contained in the resulting plasmids pBS-TEF-SANTP-BN-PHO5 and pBS-TEF-SANTP-EN-PHO5 were incorporated into the A. adeninivorans plasmid pAL-ALEU2m via the restriction sites ApaI and SalI. The obtained plasmids pAL-ALEU2m-SANTP-BN and pAL-ALEU2m-SNATP-EN could be directly transformed into A. adeninivorans G1211 [aleu2] after linearization with NcoI.

All A. adeninivorans G1211 transformants were selected in this transformation strategy via complementation of the aleu2 mutation by the ALEU2m gene. They contain 1-2 plasmid copies which were stably integrated into the chromosomal 25S rDNA.

b) Recombinant Anthocyanase (SANTP-BN/SANTP-EN)

A. adeninivorans G1211/pAL-ALEU2m-SANTP-BN and A. adeninivorans G1211/pAL-ALEU2m-SANTP-EN were tested for recombinant anthocyanase (SANTP). To perform this test, the recombinant enzyme was isolated and biochemically characterized.

The Arxula transformants were tested for anthocyanase by determining the β-glucosidase as well as the anthocyanase activities. For doing so, the A. adeninivorans G1211/pAL-ALEU2m-SANTP strains were cultivated in YMM with 2% saccharose, every 24 hours 5 ml samples were taken and the secreted recombinant enzyme contained therein was detected. As the β-glucosidases of some fungi are inhibited by glucose, saccharose was selected as C-source of the YMM. The β-glucosidase activity of the taken samples was measured; however, no activity could be detected. Only after a 10-fold concentration of the samples was β-glucosidase activity detected.

For determining the anthocyanase activity, 50 μl samples were applied onto an anthocyanin-containing agar plate. As a negative control, 50 μl of the corresponding samples were inactivated and also applied onto the anthocyanin plates. After the incubation at 37° C., however, in all samples a corona formation could be observed. This means that with these transformants hydration takes place, and thus the anthocyanase activity cannot be detected by this route of examination. In the former examinations, moreover no differences between A. adeninivorans G1211/pAL-ALEU2m-SANTP-BN and A. adeninivorans G1211/pAL-ALEU2m-SANTP-EN could yet be detected.

In order to determine the difference of the properties of the recombinant anthocyanase from those of the anthocyanin-β-glucosidase synthesized in Sch. pombe, the optimum temperature and pH, Kₘ value and the substrate spectrum of the recombinant enzyme were determined via β-glucosidase activity. Thus, the recombinant anthocyanase has similar parameters as the Sch. pombe enzyme.

The temperature optimum was determined to be 50° C. The temperature range in which this anthocyanase was still more than 80% active was between 45° C. and 50° C. The temperature optimum of the anthocyanase of Sch. pombe was somewhat lower at only 40° C.

The pH value optimum was 5.0, while the anthocyanase of Sch. pombe has a pH optimum of 4.0. However, both enzymes still show an activity of 80% between the pH values 4.5-5.5. The Kₘ value of cellobiose was established to be 11.19 mM. Moreover, the substrate spectrum was established. The results are shown in Table 11.

TABLE 11
Substrate spectrum of r-enzyme-3 (recombinant anthocyanase
of S. pombe produced in Arxula adeninivorans)

| Substrates | Configuration of the | Enzyme activity |
|---|---|---|
| [10 mM] | glucose ligation | [nkat/ml] at pH 4.0 |
| Amygdalin | Glc (β1→6) | 19.94 |
| Cellobiose | Glc (β1→4) | 3.14 |
| Gentiobiose | Glc (β1→6) | 3.04 |
| Lactose | Gal (β1→4) Glc | 0 |
| Maltose | Glc (α1→4) | 18.42 |
| Maltotriose | (α1→4) Glc | 42.36 |
| Saccharose | Glc (α1 [symbol] 2β) Fru | 11.65 |
| Salicin | Glc (β1→4) | 0 |

In order to compare the catalytic capabilities of the anthocyanase of Sch. pombe with those of the recombinant anthocyanase (SANTPp), this enzyme was also tested for its catalytic action on the specific anthocyanins. The results of the enzyme are shown in Table 12.

TABLE 12
Catalytic action of the anthocyanase r-enzyme-3 (recombinant
anthocyanase of S. pombe produced in Arxula adeninivorans)
on various anthocyanins

| Anthocyanins | Catalytic reaction |
|---|---|
| Cyanidin-3-O-glucoside | present |
| Cyanidin-3-O-galactoside | not present |
| Cyanidin-3-O-rutinoside | not present |
| Cyanidin-3,5-di-O-glucoside | not present |

The examination results demonstrate that the recombinant anthocyanase (SANTP) only has a catalytic activity with cyanidin-3-O-glucoside, not, however, with cyanidin-3,5-di-O-glucoside.

c) Construction of A. adeninivorans G1211/pAL-ALEU2m-DANTH (D. hansenii)

The construction of the A. adeninivorans G1211/pAL-ALEU2m-DANTH strains was performed analogously to the A. adeninivorans G1211/pAL-ALEU2m-SANTP strains. Here, too, two different restriction sites were used. Thus, the DANTH-ORF was amplified by means of gene-specific primers and chromosomal D. hansenii DNA as template and flanked first with the restriction sites for EcoRI and NotI and secondly with the restriction sites BglII and NotI. The obtained DNA fragments of 2528 bp were cloned into the pCR®2.1-TOPO vector by means of the TOPO TA Cloning Kit and transformed into E. coliTOP 10 F′.

From the obtained E. coli transformants, the pDNA was subsequently isolated, and the transformants containing the complete DANTH-gene fragment were selected by BglII-NotI and EcoRI-NotI restriction.

The fragment was sequenced and the obtained sequence data were compared to those of the DANTH-gene sequence known from databases. In this manner, the correct amplification of the DANTH fragment was detected.

Analogous to the SANTP-DNA fragments, the DANTH-DNA fragments were integrated into the plasmid pBS-TEF-PHO5 between the TEF1 promotor and the PHO5 terminator. To accomplish this, the fragments were cut out of the respective plasmid pCR2.1-DANTH as BglI-NotI and EcoRI-NotI. The BglI-NotI fragment was incorporated into the BamHI-NotI cut pBS-TEF-PHO5 plasmid, and the EcoRI-NotI fragment was incorporated into the EcoRI-NotI cut plasmid pBS-TEF-PHO5. In the process, the EcoRI-NotI fragment was positioned analogously to the EcoRI-NotI SANTP fragment some bases nearer to the promoter than the BglI-NotI fragment. Possibly, this different positioning has an influence on the later expression in A. adeninivorans G1211. In the next cloning step, the expression cassettes contained in the resulting plasmids pBS-TEF-DANTH-BN-PHO5 and pBS-TEF-DANTH-EN-PHO5 are incorporated into the A. adeninivorans plasmid pAL-ALEU2m via the restriction sites ApaI and SalI. The obtained plasmids pAL-ALEU2m-DANTH-BN and pAL-ALEU2m-DANTH-EN are then directly transformed into A. adeninivorans G 1211 [aleu2] after linearization with BglII.

The disclosures of each and every patent, patent application, and publication cited herein are hereby incorporated herein by reference in their entirety.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed:

1. A detergent comprising at least one anthocyanase (anthocyanin-β-glucosidase).

2. The detergent of claim 1, wherein the anthocyanase is selected from the group consisting of C. molischiana anthocyanase, S. cerevisiae anthocyanase, Sch. pombe anthocyanase, C. maltosa anthocyanase, D. hansenii anthocyanase, D. vanrijiae anthocyanase, Y. lipolytica anthocyanase, T. beigeleii anthocyanase, T. cutaneum anthocyanase, A. adeninivorans anthocyanase, Kl. Lactis anthocyanase and P. etchellsii anthocyanase.

3. The detergent of claim 1, wherein the anthocyanase is selected from the group consisting of C. molischiana anthocyanase, S. cerevisiae S288C anthocyanase, Sch. pombe anthocyanase, C. maltosa anthocyanase, D. hansenii 528 anthocyanase, D. vanrijiae anthocyanase, Y. lipolytica H120 anthocyanase, Y. lipolytica H158 anthocyanase, T. beigeleii anthocyanase, T. cutaneum anthocyanase, A. adeninivorans LS3 anthocyanase, Kl. lactis anthocyanase and P. etchellsii anthocyanase.

4. The detergent of claim 1, wherein the anthocyanase is selected from the group consisting of C. molischiana anthocyanase, Sch. pombe anthocyanase, D. hansenii anthocyanase, and P. etchellsii anthocyanase.

5. The detergent of claim 1, wherein the anthocyanase is isolated recombinant anthocyanase or native anthocyanase.

6. The detergent of claim 5, wherein the detergent comprises at least one anthocyanase produced in non-conventional yeasts, wherein the non-conventional yeasts are selected from the group consisting of A. adeninivorans, P. pastoris and H. polymorpha.

7. The detergent of claim 1, wherein the detergent comprises at least one recombinant anthocyanase of A. adeninivorans.

8. The detergent of claim 1, wherein the detergent further comprises a buffer agent and the pH of the detergent is between 3 and 7.

9. The detergent of claim 8, wherein the pH of the detergent is between 4 and 6.

10. The detergent of claim 8, wherein the pH of the detergent is between 4 and 5.

11. The detergent of claim 8, wherein the pH is about 4.5.

12. The detergent of claim 1, wherein the detergent comprises a mixture of more than one anthocyanase.

13. The detergent of claim 1, wherein the detergent is formulated as an unconsolidated powder, tablet, liquid or gel.

14. The detergent of claim 13, wherein at least one anthocyanase is present in a powder or a tablet as a lyophylizate.

15. A method for cleaning objects, wherein at least one object is contacted with a detergent comprising at least one anthocyanase (anthocyanin-β-glucosidase) under aqueous conditions.

16. A method of decoloring objects, wherein at least one object is contacted with a detergent comprising at least one anthocyanase (anthocyanin-β-glucosidase) under aqueous conditions.

17. The method of claim 15, wherein the object is a textile.

18. The method of claim 16, wherein the object is a textile.

19. The method of claim 15, wherein the detergent is the detergent of claim 1.

20. The method of claim 16, wherein the detergent is the detergent of claim 1.

21. A method for decoloring a liquid, wherein the liquid is contacted with at least one anthocyanase (anthocyanin-β-glucosidase).

22. The method of claim 21, wherein the liquid is a fruit juice.

23. The method of claim 21, wherein the liquid is red wine.

24. A method of preventing precipitation in an anthocyanin-containing liquid, wherein the liquid is contacted with at least one anthocyanase (anthocyanin-β-glucosidase).

25. The method of claim 24, wherein the liquid is red wine.
